(19) United States
(12) Patent Application Publication
(10) Pub. No.: US 2007/0286360 A1
(43) Pub. Date: Dec. 13, 2007

(54) System and Method for Providing Screen-Context Assisted Information Retrieval

(76) Inventors: Frank Chu, Cupertino, CA (US); Corey Gates, Belmont, CA (US); Virgil Dobjanschi, Dublin, CA (US); Chris DeCenzo, San Francisco, CA (US)

Correspondence Address: DORSEY & WHITNEY LLP, 555 CALIFORNIA STREET, SUITE 1000, SUITE 1000, SAN FRANCISCO, CA, 94104, US

(21) Appl. No.: 11/687,802

(22) Filed: Mar. 19, 2007

Related U.S. Application Data
(60) Provisional application No. 60/786,451, filed on Mar. 27, 2006.

(51) Int. Cl. H04M 1/64

(52) U.S. Cl. 379/88.01; 379/88.11

(57) ABSTRACT

A system and method for context-assisted information retrieval include a communication device, such as a wireless personal communication device, for transmitting screen-context information and voice data associated with a user request to a voice information retrieval server. The voice information retrieval server utilizes the screen-context information to define a grammar set to be used for speech recognition processing of the voice frames; processes the voice frames using the grammar set to identify response information requested by the user; and convert the response information into response voice data and response control data. The server transmits the response voice data and the response control data to the communication device, which generates an audible output using the response voice data and also generates display data using the response control data for display on the communication device.

### RELATED APPLICATIONS

This application claims priority to U.S. Provisional Patent Application Ser. No. 60/786,451, filed Mar. 27, 2006, and entitled “System and Method for Providing Screen-Context Assisted Voice Information Retrieval,” which is incorporated by reference herein in its entirety.

### FIELD OF THE INVENTION

The present invention relates generally to systems and methods for providing information on a communication device. In particular, the systems and methods of the present invention enable a user to find and retrieve information using voice and/or data inputs.

### BACKGROUND

Advances in communication networks have enabled the development of powerful and flexible information distribution technologies. Users are no longer tied to the basic newspaper, television and radio distribution formats and their respective schedules to receive their voice, written, auditory, or visual information. Information can now be streamed or delivered directly to computer desktops, laptops, digital music players, personal digital assistants (“PDAs”), wireless telephones, and other communication devices, providing virtually unlimited information access to users.

In particular, users can access information with their personal communication devices (such as wireless telephones and PDAs) using a number of information access tools, including an interactive voice response (“IVR”) system, or a web browser provided on the personal communication device by a service provider. These information access tools allow the user to access, retrieve, and even provide information on the fly using simple touch button or speech interfaces.

For example, a voice portal system allows users to call via telephony and use their voice to find and access information from a predetermined set of menu options.

Most such systems, however, are inefficient as information access tools since the retrieval process is long and cumbersome, and there is no visual feedback mechanism to guide the user on what can be queried via speech. For example, in navigating the user menu/interface provided by the voice portal system, the user may be required to go through several iterations and press several touch buttons (or speak a number or code corresponding to a particular button) before the user is able to get to the information desired. At each menu level, the user often has to listen to audio instructions, which can be tedious.

Most voice portal systems also rely on full duplex voice connections between a personal communication device and a server. Such full duplex connectivity make ineffective use of the network bandwidth and wastes server processing resources, since such queries are inherently half-duplex interactions, or at best, half-duplex interactions with user interruptions.

Another approach for accessing information on a personal communication device includes a web browser provided for the communication device. The web browser is typically a version of commonly-known web browsers accessible on personal computers and laptops, such as Internet Explorer, sold by Microsoft Corporation, of Redmond, Wash., that has been customized for the communication device. For example, the web browser may be a “minibrowser” provided on a wireless telephone that has limited capabilities according to the resources available on the wireless telephone for such applications. A user may access information via a web browser on a personal communication device by connecting to a server on the communication network, which may take several minutes. After connecting to the server corresponding to one or more web sites in which the user may access information, the user has to go through several interactions and time delays before information is available on the communication device.

Similar to voice portal's deficiencies, web browsers on communication devices also do not allow a user to access information rapidly and without requiring multi-step user interactions and time delays. For example, to find the location of a nearby ‘McDonalds’ on a PDA's browser, a user is required to either click through several levels of menu (i.e., Yellow Pages->Restaurants->Fast Food->McDonalds) and/or type in the keyword ‘McDonalds’. This solution is not only slow, but also does not allow for hands free interactions.

One recent approach for accessing information on a personal communication device using voice with visual feedback is voice assisted web navigation. For example, U.S. Pat. Nos. 6,101,472, 6,311,182, and 6,636,831 all disclose systems and methods that enable a user to navigate a web browser using voice instead of using a keypad or using a device's cursor control. These systems tend to use HTTP links on the current browser page to generate grammar for speech recognition, or require custom build VXML pages to specify the available speech recognition grammar set. In addition, some of these systems (such as the systems disclosed in U.S. Pat. Nos. 6,636,831 and 6,424,945) use a client based speech recognition processor, which may not provide accurate speech recognition due to a device's limited processor and memory resources.

Another recent approach for accessing information is to use a mobile Push-to-Talk (“PTT”) device. For example, U.S. Pat. No. 6,426,956 discloses a PTT audio information retrieval system that enables rapid access to information by using voice input. However, such system does not support synchronized audio/visual feedbacks to the user, and it is not effective for guiding users in multi-step searches. Furthermore, the system disclosed therein does not utilize contextual data and/or target address to determine speech recognition queries, which makes it less accurate.

A system that supports voice query for information ideally should enable a user to say anything and should process such input with high speech recognition accuracy. However, such a natural language query system typically can not be realized with high recognition rate. On the other extreme, a system that limits available vocabulary to a small set of predefined key phrases can achieve high speech recognition rate, but has a limited value to end users. Typically, a commercial voice portal system is implemented by forcing the user to break a query into multiple steps. For example, if a user wants to ask for the location of a nearby McDonalds, a typical voice portal system guides the user to say the following phrases in 3 steps before retrieving the desired information: Yellow Pages->Restaurants->Fast Food->McDonalds. A system may improve user experience by allowing the user to say key phrases that apply to several steps below the current level (i.e., allow a user to say ‘McDonalds’ while a user is at the ‘Yellow Pages’ level menu), but doing so may dramatically increase the grammar set used for speech recognition and reduce accuracy.

On a typical voice portal system, it is difficult for users to perform multi-step information search using audio input/output as guidelines for search refinements.

Therefore, there is a need for a system and method that improves a user's ability to perform searches on a communication device using verbal or audio inputs.

### SUMMARY OF THE INVENTION

In view of the foregoing, a system and method are provided for enabling users to find and retrieve information using audio inputs, such as spoken words or phrases. The system and method enable users to refine voice searches and reduce the range and/or number of intermediate searching steps needed to complete the user's query, thereby improving the efficiency and accuracy of the user's search.

The system may be implemented on a communication device or device, such as any personal communication device that is capable of communicating via a wireless network, has a display screen, and is equipped with an input enabling the user to enter spoken (audio) inputs. Such devices include wireless telephones, PDAs, WiFi enabled MP3 players, and other devices.

A system and method in accordance with the present invention enable users to perform voice queries from a personal communication device equipped with a query button or other input by 1) highlighting a portion or all displayed data on the device screen, 2) pressing the query button, and 3) entering an audio input, such as speaking query phrases. Search results (or search refinement instructions) may be displayed on the screen and/or played back via audio to the user. Further query refinements may be performed as desired by the user by repeating steps 1) through 3).

An information retrieval system may include a communication device; and a voice information retrieval server communicatively coupled to the communication device via a network. The voice information retrieval server receives one or more data packets containing screen-context information from a communication device; receives one or more voice packets containing voice frames from the communication device, the voice frames representing a request for information input by a user; utilizes the screen-context information to define a grammar set to be used for speech recognition processing of the voice frames; processes the voice frames using the grammar set to identify response information requested by the user; generates a response to the communication device containing the response information; and transmits the response to the communication device.

A method for context-assisted information retrieval may include receiving screen-context information from a communication device, the screen-context data associated with a request for information input by a user; receiving voice data from the communication device, the voice data associated with the user's request; utilizing the screen-context information to define a grammar set to be used for speech recognition processing of the voice data; processing the voice data using the grammar set to identify response information requested by the user; generating a response to the communication device containing the response information; and transmitting the response to the communication device.

These and other aspects of the present invention may accomplished using a screen-context-assisted Voice Information Retrieval System (“VIRS”) in which a server is provided for communicating with a communication device.

These and other features and advantages of the present invention will become apparent to those skilled in the art from the following detailed description, wherein it is shown and described illustrative embodiments of the invention, including best modes contemplated for carrying out the invention. As it will be realized, the invention is capable of modifications in various aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 provides an exemplary schematic diagram of a screen-context-assisted Voice Information Retrieval System (VIRS).

FIG. 2 provides a functional block diagram of an exemplary method for providing screen-context assisted voice information retrieval.

FIG. 3 provides an exemplary one-step voice search process.

FIG. 4 provides an exemplary comparison of a grammar set that has been trimmed using the screen context info versus an untrimmed grammar set.

FIG. 5 illustrates an exemplary two-step voice search process.

FIG. 6 illustrates an exemplary call flow involving interactions between a user, a Voice Information System (VIRS) server, and a personal communication device.

### DETAILED DESCRIPTION

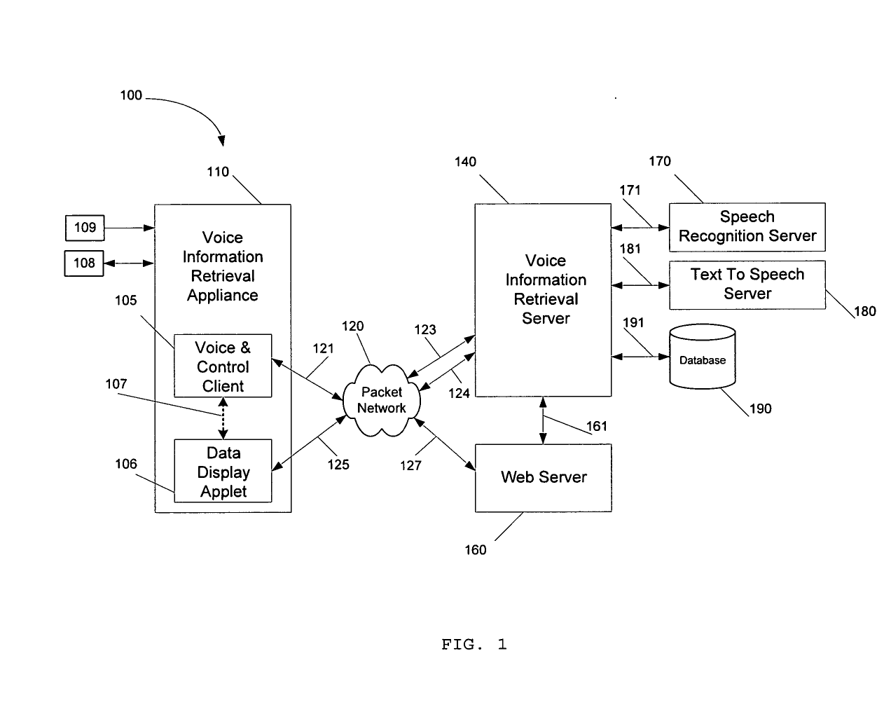

With reference to FIG. 1, a system 100 for providing screen-context assisted voice information retrieval may include a personal communication device 110 and a Voice Information Retrieval System (“VIRS”) server 140 communicating over a packet network. The VIRS personal communication device 110 may include a Voice & Control client 105, a Data Display applet 106 (e.g., Web browser, MMS client), a query button or other input 109, and a display screen 108. The input 109 may be implemented as a Push-to-Query (PTQ) button on the device (similar to a Push-to-Talk button on a PTT wireless phone), a keypad/cursor button, and/or any other button or input on any part of the personal communication device.

The communication device 110 may be any communication device, such as a wireless personal communication device, having a display screen and an audio input. This includes devices such as wireless telephones, PDAs, WiFi enabled MP3 players, and other devices.

The VIRS Server 140 may communicate with a Speech Recognition Server (“SRS”) 170, with a Text to Speech Server (“TTSS”) 180, a database 190, and/or a Web server component 160.

The system 100 may communicate via a communication network 120, for example, a packet network such as a GSM GPRS/EDGE, CDMA 1xRTT/EV-DO, iDEN, WiMax, WiFI, and/or Internet network. Alternatively or additionally, other network types and protocols may be employed to provide the functionality of the system 100.

The Voice & Control client 105 network protocols may be based on industry standard protocols such as Session Initiation Protocol (SIP), proprietary protocols, such as protocols used by iDEN, or any other desired protocols.

The server 140 to client data applet 106 interface may be based on data delivery protocols such as WAP Push or Multimedia Messaging Service (MMS). The Web Server 160 to client data applet 106 interface may be based on standard Web client-server protocols such as WAP or HTTP or any other desired protocols.

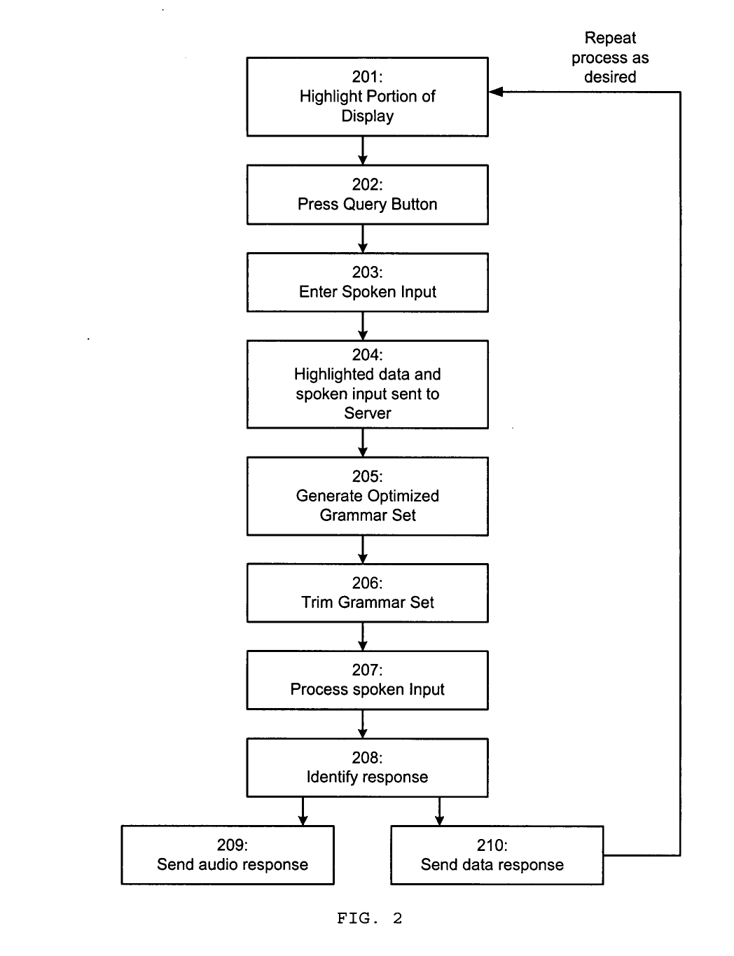

Operation of system 100 will now be described with reference to FIG. 2. In a method 200 for providing screen-context assisted voice information retrieval, a user highlights portion of the display data on the display screen of the communication device (201). The user then presses a query button (e.g., PTQ button) or otherwise inputs the highlighted data (202). Upon pressing the query button, the user also enters a spoken or other audio input (203). The spoken input and the highlighted portion of the display (e.g., the current highlighted “category”) are transmitted from the communication device (e.g., 110 in FIG. 1) to the VIRS server (e.g., 140 in FIG. 1). The client voice component 105 processes and streams the audio input to the VIRS server 140 until the query button is released.

For each query, the VIRS server uses the screen context data received from the client component to generate an optimized grammar set for each screen context (e.g. which category is highlighted), for the user, and for each query (205). The server also implements a grammar trimming function that uses ‘a priori’ data associated with the screen context and a user's query history to trim the initial grammar set for improved speech recognition accuracy (206). This trimmed and optimized grammar set enables improved recognition of the audio input to enable efficient and accurate generation of a response to the communication device 110 from the VIRS server 140 (207).

After identifying the appropriate response to the user's query (208), the VIRS server may respond to a query by sending audio streams over the media connection to the client device (209). The VIRS server may also and/or alternatively send control messages to the Voice & Control client component and to instruct it to navigate to a new link (e.g., the Web page corresponding to the query) and to display the queried results (210). In one implementation, text and/or graphic query results are displayed on the user's display screen while audio is played back to the user.

The method 200 of FIG. 2 may be repeated in accordance with the query of the user. For example, the method 200 may be implemented in multiple steps, with each step bringing incremental refinement to the search. With each step, the device's data display may list new “categories” that can help a user refine further searches. If a user highlights a category, presses the device's query button, and speaks key phrase(s), the query process repeats as described above.

With reference to FIG. 1, for each query, the VIRS server 140 uses the screen context data (the highlighted display data entered by the user upon pressing the query button) received from the client component 105 to generate an initial optimized grammar set for each highlighted screen context, for each user, and for each query. The VIRS server 140 may also use ‘a priori’ data associated with the screen context data and/or a user's query history to trim the initial optimized grammar set for improved speech recognition accuracy. The VIRS server 140 may retrieve the ‘a priori’ data from the database component 190, Web services over the Internet, its internal memory cache of previously retrieved data, and/or other sources.

The data displayed on display 108 may be generated in various ways. For example, in one exemplary embodiment, screen context data is in the form of a HTTP link. When the user highlights a link and presses the query button, thereby transmitting the highlighted link and a spoken input to server 140, server 140 generates an optimized grammar set by crawling through one or more sub-levels of HTTP links below the highlighted “category” and constructing key phrases from links found on the current level and on all sub levels. The VIRS server 140 subsequently trims the possible key phrases by using ‘a priori’ data associated with the “category” (e.g., HTTP link). Additional details of this process are provided below with reference to FIG. 2.

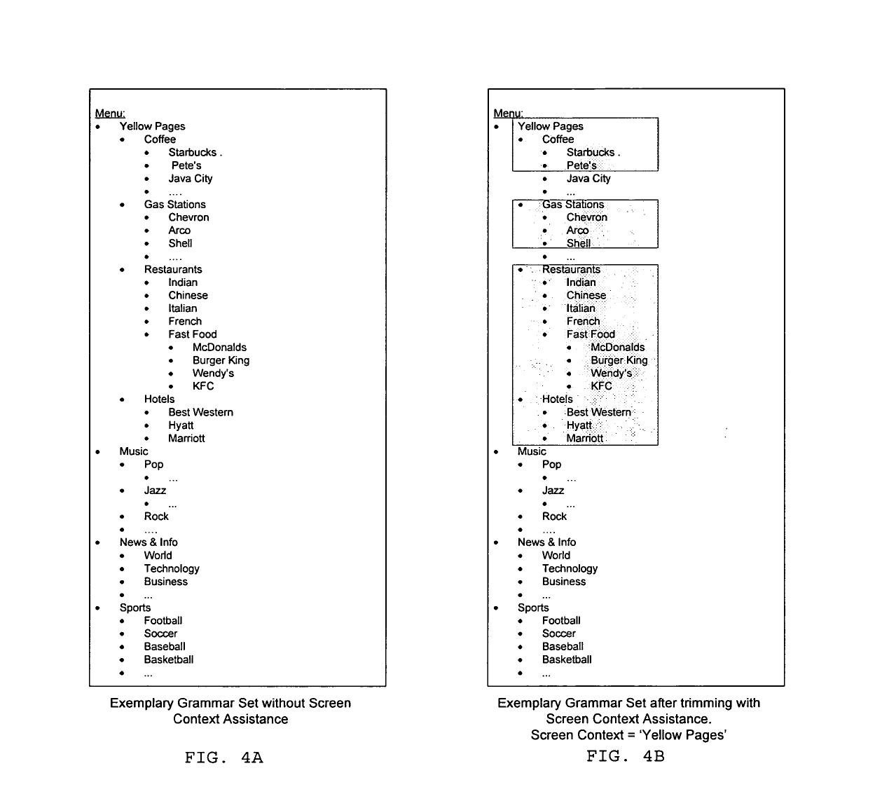

‘A priori’ data for use in trimming the optimized grammar set may be obtained or generated in a variety of ways. For example, “a priori” data associated with a HTTP link may include a set of data collected from Web traffic usage for that particular HTTP link. For example, a local yellow page web site may collect what are the most likely links to be clicked on or phrases to be typed in once a user has clicked on the HTTP link in question. In the example shown in FIG. 4B (discussed in further detail below), Web usage pattern collected a priori for the ‘http://yellow-pages/coffee’ link is used to trim the number of possible ‘coffee’ sub-categories to two (Starbucks, Pete's) from a long list of possible coffee sub-categories.

‘A priori’ data may also be used by the server 140 to prioritize key phrases based on a financial value associated with the phrase. For example, ‘Starbucks’ may be assigned a higher financial value and thus placed higher in the list of possible “coffee” categories in the grammar.

In yet another example, the grammar trimming function may use historical voice query data in conjunction with Web traffic usage data to reduce the grammar set. For example, the historical voice query data may be based upon queries associated with a specific user and/or based upon general population trends.

VIRS server 140 may also utilize user-specific data as part of its grammar trimming function. The VIRS server 140 may keep track of each caller's unique identifier (e.g., caller ID) and use it to process each of the user's queries. Upon receiving a query call from the user, the VIRS server 140 may extract the “caller ID” in the signaling message to identify the caller, and retrieve user-specific data associated with the extracted “caller ID”. An example of user-specific data is a user's navigation history. If a user often asks for ‘Pete's’, the VIRS server 140 uses this user specific data to weight more heavily toward keeping ‘Pete's’ in the grammar for the current query.

The VIRS server 140 may respond to each query by sending audio feedback and/or data feedback to the user. Text/graphic query results may be displayed on the device screen while audio is playing back to the user. Audio feedback may be sent in the form of audio stream over the packet network 120 to the Voice & Control Client 105, and then played out as audio for the user.

Various methods may be used to send text/graphics feedback to the user. For example, VIRS server 140 may send a navigation command (with a destination link such as a URL) to the Voice & Control client 105, which in turn relays the navigation command to the Data Display client 106 via an application to application interface 107 between the two clients. Upon receiving such a navigation command, the Data Display client 106 will navigate to the new destination specified by the navigation command (i.e., a browser navigates to a new URL and displays its HTML content).

Alternatively, VIRS server 140 may send text/graphic data to the Data Display Applet 106 directly. This may be accomplished via one of many standard methods, such as WAP-Push, SMS messaging, and/or MMS messaging. If WAP-Push is to be used, a WAP Gateway may be required in the packet network 120 and a WAP client may be required at the communication device 110. If SMS/MMS messaging is to be used, a SMS/MMS gateway may be required at the network 120 and a SMS/MMS client may be required at the communication device 110. Other methods of sending text and graphics feedback data to the user's communication device may also be employed.

The user request & server response process may be repeated in multiple steps, with each step bringing refinement to the search. With each step, the communication device's data display may list new “categories” that may help a user refine further searches. If a user highlights a category, presses the device's query button, and speaks one or more key words or phrases, the query process may be repeated as described above with reference to FIG. 2.

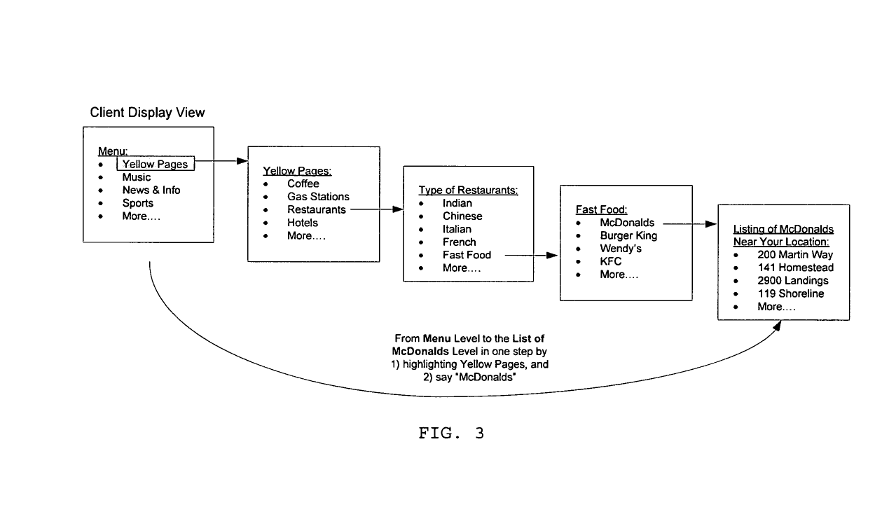

Example of the operation of system 100 is provided with reference to FIGS. 3-5. FIG. 3 depicts a one-step query example that demonstrates how a user may efficiently and accurately locate information that is several levels below the current level. In this example, a user highlights the term “Yellow Pages” on the display screen (e.g., 108 in FIG. 1), presses the query button (e.g., 109 in FIG. 1), and enters the spoken input “McDonald's.” In response, the server 140 identifies the “Yellow Pages” optimized grammar set (see FIG. 4). The server 140 may then either search the categories under “Yellow Pages” for “McDonald's” or use “a priori” data (such as historical user queries, population trends, financial priority data, etc.) to further trim the “Yellow Pages” optimized grammar set prior to searching for “McDonald's.” In this way, server 140 identifies the “Restaurant” category, identifies the “Fast Food” category, and then displays the possible locations for McDonald's restaurant. Thus, in response to receiving “Yellow Pages” context data and the spoken input “McDonald's,” system 100 is able to identify and retrieve the information sought by the user efficiently and accurately.

FIG. 4 provides additional details concerning the example of FIG. 3. FIG. 4 illustrates the difference in grammar size between a trimmed grammar list and a non-trimmed grammar list. FIG. 4A lists a large grammar set without trimming. FIG. 4B lists a smaller grammar list (highlighted) that was trimmed using 1) the screen context data (e.g., ‘Yellow Pages’) and 2) the caller's past query history.

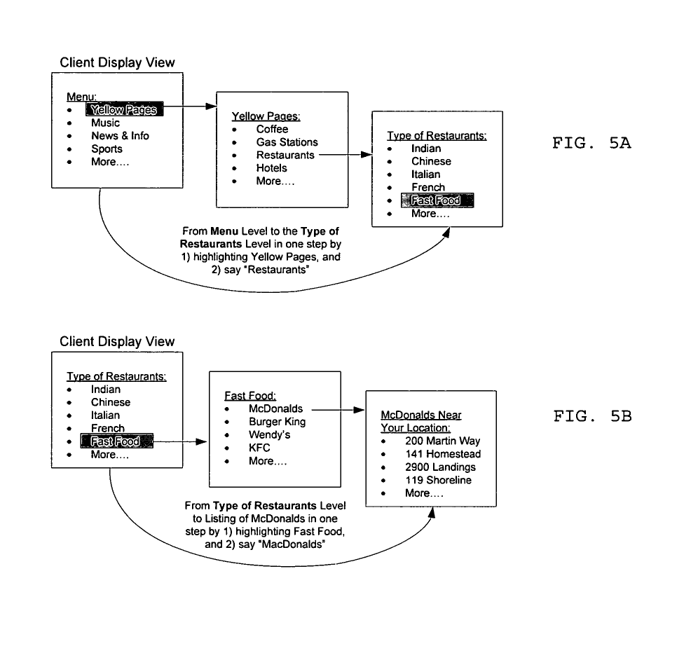

FIG. 5 depicts an alternative query example involving a two-step search process. FIG. 5A illustrates the first query step where the ‘Yellow Pages’ category is highlighted and with ‘Restaurants’ as voice input. This step yields an intermediate result showing five sub-categories of Restaurants (Indian, Chinese, Italian, French, and Fast Food). FIG. 5B illustrates the second query step where the user highlights ‘Fast Food’ and says ‘McDonalds’. This second query jumps to the listing of McDonalds.

If a user enters a spoken input containing a phrase that has been trimmed from the grammar list or is otherwise not recognized by the Speech Recognition Server 170, the server may streams audio to the communication device 110 to inform the user that the input phrase was not found. The server may also sends control message(s) to the Voice & Control client component 105, which may send a command to the client data applet 106 to navigate to an intermediate HTTP link asking for further refinement.

Server Components

In addition to the server functionalities described above, the VIRS server component 140 may also maintain state or status information for a call session such that subsequent push-to-query (PTQ) presses may be remembered as part of the same session. This is useful for multi-step searches where multiple queries are made before finding the desired information. The server uses such user specific state information to determine if the current query is continuation of the same query or a new query. A session may be maintained by the VIRS server component 140 in active state until a continuous period of configurable inactivity (such as 40 seconds) occurs. A session may involve multiple PTQ calls, each with one or more PTQ presses.

VIRS server component 140 may also interface with external systems, e.g., public/private web servers (component 160), to retrieve data necessary for generating custom contents for each user. For example, VIRS server component 140 may query a publicly available directory web site to retrieve its HTML content and to generate an initial set of non-trimmed grammar. VIRS server component 140 may cache this data from the web site for subsequent fast response.

The Speech Recognition Server (SRS) component 170 may be a commercially available speech recognition server from vendors such as Nuance of Burlington, Mass. Speech grammar and audio samples are provided by the VIRS server 140. The SRS component 170 may be located locally or remotely over the Internet with other system components as shown in FIG. 1.

The Text to Speech Server (TTS) component 180 may be implemented using a commercially available text to speech server from vendors such as Nuance of Burlington, Mass. The VIRS server 140 provides grammar and commands to the TTS when audio is to be generated for a given text. The TTS 180 may be located locally or remotely over the Internet with other system components as shown in FIG. 1.

The Database component 190 may be a commercially available database server from vendors such as Oracle of Redwood City, Calif. The database server 190 may be located locally or remotely over the Internet with other system components as shown in FIG. 1.

Client Component

Communication device 110 may contain two software clients used in the Screen-Context Assisted Information Retrieval System. The two software clients are the Voice & Control Client 105 and the Data Display applet/client 106.

The Voice & Control client component 105 may be realized in many technologies, such as Java, BREW, Windows application, and/or native device software. An example of a Voice & Control client component 105 is a Push-to-Talk over Cellular (“PoC”) client conforming to the OMA PoC standard. Another example is an iDEN PTT client in existing PTT mobile phones sold by an operator such as Sprint-Nextel of Reston, Va. Upon a PTQ push, the Voice & Control client 105 is responsible for processing user input audio, optionally compressing the audio, communicating through the packet network 120 to setup a call session, and transmitting audio. The Voice & Control client is also responsible for transmitting screen-context data to the VIRS server via interfaces 121 and 123. The screen-context data may either be polled from the Data Display Applet 106 or pushed by the Data Display Applet 106 to the Voice & Control client via interface 107.

The Data Display applet 106 may be realized in many technologies, such as Java, BREW, Windows application, and/or native device software. An example of this applet is a WAP/mini-Web browser residing in many mobiles phones today. Another example is a non-HTML based client-server text/graphic client that displays data from a server. Yet another example is the native phone book or recent call list applet in use today on mobile phone devices such as an iDEN phone. The Data Display applet 106 is responsible for displaying text/graphic data retrieved or received over interface 125. The Data Display applet 106 identifies item on the device's display screen that has the current cursor focus (i.e., which item is highlighted by the user). In an example where an iDEN phone's address book serves as an exemplary applet, when a user selects a number from the list, the address book applet identifies the number selected by the user and transmits this context data to the handset's Voice & Control client. In another example where the Data Display Applet 106 is a Web browser, the browser applet identifies the screen item that has the current cursor focus and provides this information when requested by the Voice & Control client 105.

Packet Network Component

The network 120 may be realized in many network technologies, such as GSM GPRS/EDGE, CDMA 1xRTT/EV-DO, iDEN, WiMax, WiFI, and/or Ethernet packet networks. The network technology used may determine the preferred VIRS client 110 embodiment and communication protocols for interfaces 121, 123, 124, 125, and 127. For example, if the network 120 is a packet network utilizing iDEN technology, then the preferred embodiment of Voice & Control Client 105 is an iDEN PTT client using the iDEN PTT protocol for interface 121 and using WAP-Push protocol for interface 124. Whereas a different example that utilizes GSM GPRS for network 120 may prefer a PoC-based Voice & Control client 105 and a WAP browser based Data Display Applet 106, using WAP for interfaces 125 and 127. Other network technologies may also be used to implement the functionality of system 100.

System Interfaces

Various system interfaces are provided within the Screen-Context Assisted Voice Information Retrieval system 100, including: (1) interface 107 between Voice & Control client component 105 and Data Display Applet component 106; (2) interface 121 between Voice & Control component 105 and Packet Network 120; (3) interface 123 between Packet Network 120 and VIRS server 140; (4) interface 125 between Data Display Applet component 106 and Packet Network 120; (5) optional interface 124 between the VIRS server 140 and Packet Network 120; (6) interface 127 between the Web Server 160 and Packet Network 120; (7) interface 171 between VIRS server component 140 and SRS component 170; (8) interface 181 between VIRS server component 140 and TTS server component 180; and (9) interface 191 between VIRS server and database component 190.

Interface 107 between Voice & Control client component 105 and Data Display Applet component 106 may be implemented with OS specific application programming interface (API), such as the Microsoft Windows API for controlling a Web browser applet and for retrieving current screen cursor focus. Interface 107 may also be implemented using function calls between routines within the same software program.

Interface 121 between Voice & Control client component 105 and Packet Network component 120 may be implemented with standard industry protocols, such as OMA PoC, plus extensions for carrying Data Applet control messages. This interface supports call signaling, media streaming, and optional Data Applet control communication between the client component 105 and Packet Network 120. An example of an extension for carrying Data Applet control messages using the SIP protocol is to use a proprietary MIME body within a SIP INFO message. Interface 121 may also be implemented using a proprietary signaling and media protocol, such as the iDEN PTT protocol.

Interface 123 between Packet Network 120 and VIRS server 140 may be implemented with standard industry protocols, such as OMA PoC, plus extensions for carrying Data Applet control messages. Interface 123 differs from interface 121 in that it may be a server to server protocol in case where a communication server (such as a PoC server) acts as an intermediary between the client component 105 and the VIRS server 140. In such an example using PoC server, interface 124 is based on the PoC Network-to-Network (NNI) protocol plus extensions for carrying Data Applet control messages. The above example does not limit interface 123 to be different from interface 121.

Interface 124 between the VIRS server 140 and Packet Network 120 may be implemented with standard industry protocols, such as WAP, MMS, and/or SMS. Text/graphic data to be displayed to the user is transmitted over this interface. This interface is optional and is only used when the VIRS server sends WAP-Push, MMS, and/or SMS data to client component 106.

Interface 125 between Data Display Applet component 106 and Packet Network 120 may be implemented with standard industry protocols, such as WAP, HTTP, MMS, and/or SMS. Text/graphic data to be displayed to the user is transmitted over this interface.

Interface 127 between the Web Server 160 and Packet Network 120 may be implemented with standard industry protocols, such as WAP, HTTP. Text/graphic data to be displayed to the user is transmitted over this interface.

Interface 161 between the Web Server 160 and VIRS server 140 may be implemented with standard industry protocols, such as HTTP. This interface is optional. The VIRS server may use this interface to retrieve data from the Web Server 160 in order to generate an initial grammar set for a particular query.

Interface 171 between VIRS server component 140 and SRS component 170 may be implemented with a network based protocol that supports transmission of 1) grammar to be used for speech recognition, and 2) audio samples to be processed. This interface may be implemented with industry standard protocols such as the Media Resource Control Protocol (MRCP) or with a proprietary protocol compatible with vendor specific software API.

Interface 181 between VIRS server component 140 and TTS server component 180 may be implemented with a network based protocol that supports transmission of 1) text-to-speech grammar to be used for audio generation, and 2) resulting audio samples generated by the TTS server 180. This interface may be implemented with an industry standard protocol such as Media Resource Control Protocol (“MRCP”) or with a proprietary protocol compatible with a vendor specific software API.

Database Interface 191 between VIRS server and database component 190 may be based on commercially available client-server database interface such as an interface supporting SQL queries. This interface may run over TCP/IP networks or networks optimized for database such as Storage Area Network (SAN).

Call Flow

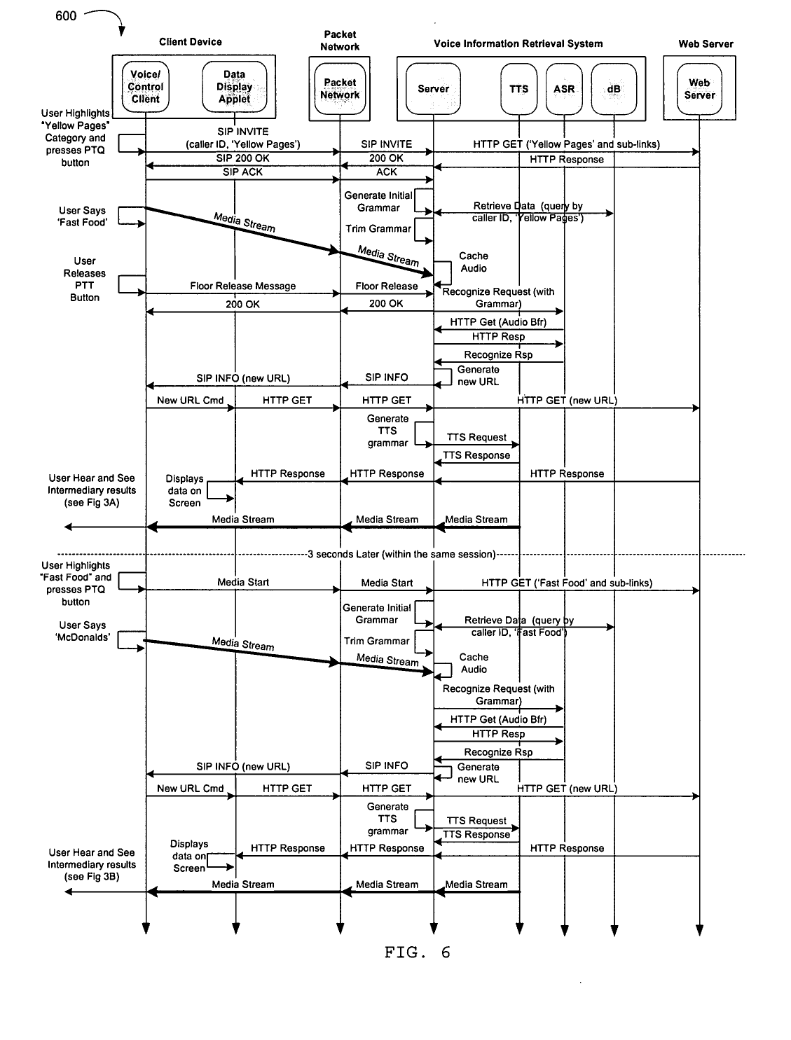

Referring now to FIG. 6, an exemplary call flow involving interactions between a user, a VIRS server, and a VIRS device is provided. Exemplary call flow 600 uses SIP as a PTQ call setup protocol between a Voice & Control client component 105 and VIRS server 140. However, as understood by one skilled in the art, this disclosure is not limited to the use of SIP such that other signaling and media protocols may be used with Voice Information Retrieval System 100.

It should be understood by one skilled in the art that additional components may be included in the VIRS system shown in FIG. 1 without deviating from the principles and embodiments of the present invention. For example, VIRS system 100 may include one or more Data Display Applet components 106 in personal communication device 110 for the purposes of using different user interface options.

The foregoing descriptions of specific embodiments and best mode of the present invention have been presented for purposes of illustration and description only. They are not intended to be exhaustive or to limit the invention to the precise forms disclosed. Specific features of the invention are shown in some drawings and not in others, for purposes of convenience only, and any feature may be combined with other features in accordance with the invention. Steps of the described processes may be reordered or combined, and other steps may be included. The embodiments were chosen and described in order to best explain the principles of the invention and its practical application, to thereby enable others skilled in the art to best utilize the invention and various embodiments with various modifications as are suited to the particular use contemplated. Further variations of the invention will be apparent to one skilled in the art in light of this disclosure and such variations are intended to fall within the scope of the appended claims and their equivalents. The publications referenced above are incorporated herein by reference in their entireties.

We claim:

1. An information retrieval system, comprising:
a communication device; and
a voice information retrieval server communicatively coupled to the communication device via a network,
wherein the voice information retrieval server:
receives screen-context information from a communication device;
receives voice frames from the communication device, the voice frames representing a request for information input by a user;
utilizes the screen-context information to define a grammar set to be used for speech recognition processing of the voice frames;
processes the voice frames using the grammar set to identify response information requested by the user;
generates a response to the communication device containing the response information; and
transmits the response to the communication device.

2. A method for context-assisted information retrieval, the method comprising:
receiving screen-context information from a communication device, the screen-context data associated with a request for information input by a user;
receiving voice data from the communication device, the voice data associated with the user's request;
utilizing the screen-context information to define a grammar set to be used for speech recognition processing of the voice data;
processing the voice data using the grammar set to identify response information requested by the user;
generating a response to the communication device containing the response information; and
transmitting the response to the communication device.

3. The method of claim 2, wherein the screen-context data is entered by the user into the communication device using an input device on the communication device.

4. The method of claim 2, wherein the communication device comprises a display screen and the communication device generates a display of the response that is displayed on the display screen.

5. The method of claim 4, wherein the response is displayed in the form of a screen cursor focus, an underline phrase, a highlighted object, or a visual indication on a display screen.

6. The method of claim 4, wherein the response is displayed in the form of a HTTP link.

7. The method of claim 2, wherein the screen-context data is used to retrieve ‘a priori’ data associated with the user's request.

8. The method of claim 7, wherein the ‘a priori’ data is used to trim the grammar set.

9. The method of claim 8, wherein the “a priori” data comprises user-specific data.

10. The method of claim 2, wherein the screen-context data, voice data and response are transmitted via a wireless packet network, and the voice data is transmitted in voice packets that are compressed using one or more audio compression algorithms.

11. The method of claim 2, wherein the user transmits multiple screen-context data and voice data messages within one query session.

12. A method for context-assisted information retrieval, the method comprising:
transmitting screen-context information from a communication device to a voice information retrieval server, the screen-context data associated with a user request for information;
transmitting voice data from the communication device to the voice information retrieval server, the voice data associated with the user request;
utilizing the screen-context information to define a grammar set to be used for speech recognition processing of the voice frames;
processing the voice frames using the grammar set to identify response information requested by the user;
converting the response information into response voice data;
converting the response information into response control data;
transmitting the response voice data and the response control data to the communication device;
receiving the response voice data and the response control data at the communication device;
generating an audible output using the response voice data, wherein the audible output is provided by the communication device; and
generating display data using the response control data, wherein the display data is displayed by the communication device.

13. The method of claim 12, wherein the screen-context data and voice data are entered by the user into the communication device using an input device on the communication device.

14. The method of claim 12, wherein the response control data is displayed in the form of a screen cursor focus, an underline phrase, a highlighted object, or a visual indication on a display screen.

15. The method of claim 14, wherein the response control data is displayed in the form of a HTTP link.

16. The method of claim 12, wherein the screen-context data is used to retrieve ‘a priori’ data associated with the user's request.

17. The method of claim 16, wherein the ‘a priori’ data is used to trim the grammar set.

18. The method of claim 12, wherein the screen-context data, voice data and response are transmitted via a wireless packet network, and the voice data is transmitted in voice packets that are compressed using one or more audio compression algorithms.

19. The method of claim 12, wherein the user transmits multiple screen-context data and voice data messages within one query session.

20. An information retrieval system, comprising:
a communication device; and
a voice information retrieval server communicatively coupled to the communication device,
wherein the voice information retrieval server:
receives one or more data packets containing screen-context information from a communication device;
receives one or more voice packets containing voice frames from the communication device, the voice frames representing a request for information input by a user;
utilizes the screen-context information to define a grammar set to be used for speech recognition processing of the voice frames;
processes the voice frames using the grammar set to identify response information requested by the user;
converts the response information into response voice data;
converts the response information response control data; and
transmits the response voice data and the response control data to the communication device; and
wherein the communication device receives the response voice data and the response control data, generates an audible output using the response voice data, and generates display data using the response control data.
